(19) United States
(12) Patent Application Publication
(10) Pub. No.: US 2023/0334880 A1
(43) Pub. Date: Oct. 19, 2023

(54) HOT WORD EXTRACTION METHOD AND APPARATUS, ELECTRONIC DEVICE, AND MEDIUM

(71) Applicant: BEIJING BYTEDANCE NETWORK TECHNOLOGY CO., LTD., BEIJING (CN)

(72) Inventors: Bowen ZONG, BEIJING (CN); Xiang ZHENG, BEIJING (CN); Wenming XU, BEIJING (CN); Jingsheng YANG, BEIJING (CN)

(21) Appl. No.: 18/043,522

(22) PCT Filed: Aug. 25, 2021
(86) PCT No.: PCT/CN2021/114565

§ 371 Date: Feb. 28, 2023

(30) Foreign Application Priority Data
Aug. 31, 2020 (CN) 202010899806.4

(51) Int. Cl. G06V 20/62; G06V 30/14; G06V 20/40; G06V 30/19; G10L 15/08; G10L 25/57

(52) U.S. Cl. CPC G06V 20/63; G06V 30/1448; G06V 20/48; G06V 20/46; G06V 30/19147; G10L 15/08; G10L 25/57; G10L 2015/088

(57) ABSTRACT

Provided are a hot word extraction method and apparatus, an electronic device, and a storage medium. The method includes that a target key video frame is determined, that a target region in the target key video frame is determined, that target content in the target key video frame is determined based on the target region, and that a hot word of the target key video frame is determined by processing the target content.

The present application claims priority to Chinese Patent Application No. 202010899806.4 filed with the China National Intellectual Property Administration (CNIPA) on Aug. 31, 2020, the disclosure of which is incorporated herein by reference in its entirety.

### TECHNICAL FIELD

Embodiments of the present disclosure relate to the field of computer technology, for example, a hot word extraction method and apparatus, an electronic device, and a medium.

### BACKGROUND

With the development of Internet communication technology, more and more users prefer online communication.

In online communication, a user needs to determine the core discussed in a current video or a core word corresponding to the video reference according to audio content and/or content displayed on a display interface.

However, in an actual application process, the user may not understand conference content well, resulting in an inaccuracy in the determined core content and thus leading to a technical problem of low interactive efficiency.

### SUMMARY

The present disclosure provides a hot word extraction method and apparatus, an electronic device, and a storage medium to implement a rapid and convenient determination of a hot word in a target video. Accordingly, a hot word corresponding to speech information is determined in a speech-to-text process, thus improving the accuracy and convenience of a speech-to-text conversion.

In a first aspect, embodiments of the present disclosure provide a hot word extraction method. The method includes the steps below.

A target key video frame is determined. A target region in the target key video frame is determined.

Target content in the target key video frame is determined based on the target region.

A hot word of a target video to which the target key video frame belongs is determined by processing the target content.

In a second aspect, embodiments of the present disclosure further provide a hot word extraction apparatus. The apparatus includes a key video frame determination module, a target region determination module, a target content determination module, and a hot word determination module.

The key video frame determination module is configured to determine a target key video frame.

The target region determination module is configured to determine a target region in the target key video frame.

The target content determination module is configured to determine target content in the target key video frame based on the target region.

The hot word determination module is configured to determine, by processing the target content, a hot word of a target video to which the target key video frame belongs.

In a third aspect, embodiments of the present disclosure further provide an electronic device. The electronic device includes at least one processor and a storage apparatus configured to store at least one program.

When executed by the at least one processor, the at least one program causes the at least one processor to perform the hot word extraction method described in the first aspect of the present application.

In a fourth aspect, embodiments of the present disclosure further provide a storage medium including computer-executable instructions. When the computer-executable instructions are executed by a computer processor, the hot word extraction method described in the first aspect of the present application is performed.

### BRIEF DESCRIPTION OF DRAWINGS

FIG. 1 is a flowchart of a hot word extraction method according to embodiment one of the present disclosure.

FIG. 2 is a flowchart of a hot word extraction method according to embodiment two of the present disclosure.

FIG. 3 is a flowchart of a hot word extraction method according to embodiment three of the present disclosure.

FIG. 4 is a flowchart of a hot word extraction method according to embodiment four of the present disclosure.

FIG. 5 is a view of a hot word extraction interface according to embodiment four of the present disclosure.

FIG. 6 is a view of another hot word extraction interface according to embodiment four of the present disclosure.

FIG. 7 is a view of another hot word extraction interface according to embodiment four of the present disclosure.

FIG. 8 is a view of another hot word extraction interface according to embodiment four of the present disclosure.

FIG. 9 is a flowchart of a hot word extraction method according to embodiment five of the present disclosure.

FIG. 10 is a diagram illustrating the structure of a hot word extraction apparatus according to embodiment six of the present disclosure.

FIG. 11 is a diagram illustrating the structure of an electronic device according to embodiment seven of the present disclosure.

### DETAILED DESCRIPTION

Embodiments of the present disclosure are described in more detail hereinafter with reference to the drawings.

It is to be understood that the various steps recorded in the method embodiments of the present disclosure may be performed in a different order, and/or in parallel. In addition, the method embodiments may include additional steps and/or omit performing the illustrated steps. The scope of the present disclosure is not limited in this respect.

As used herein, the term “include” and variations thereof are intended to be inclusive, that is, “including, but not limited to”. The term “based on” is “at least partially based on”. The term “one embodiment” means “at least one embodiment”; the term “another embodiment” means “at least one another embodiment”; and the term “some embodiments” means “at least some embodiments”. Related definitions of other terms are given in the description hereinafter.

It is to be noted that references to “first”, “second” and the like in the present disclosure are merely intended to distinguish one from another apparatus, module, or unit and are not intended to limit the order or interrelationship of the functions performed by the apparatus, module, or unit.

It is to be noted that references to modifications of “one” or “a plurality” in the present disclosure are intended to be illustrative and not limiting, and that those skilled in the art should understand that “at least one” is intended unless the context clearly indicates otherwise.

### Embodiment One

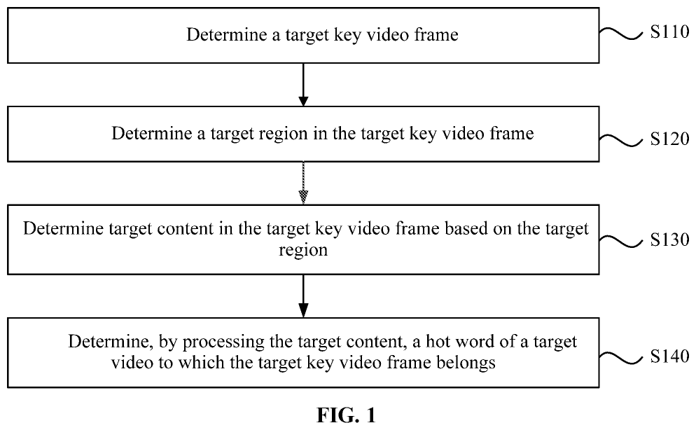

FIG. 1 is a flowchart of a hot word extraction method according to embodiment one of the present disclosure. Embodiments of the present disclosure are applicable to the case where a hot word of a video is determined based on a plurality of video frames in the video, thus determining a hot word corresponding to speech information in a speech-to-text process so as to improve the accuracy of a speech-to-text conversion. The method may be performed by a hot word extraction apparatus which may be implemented in the form of software and/or hardware. Optionally, the hot word extraction apparatus may be implemented by an electronic device which may be, for example, a mobile terminal, a personal computer (PC) terminal, or a server. Technical solutions for implementing embodiments of the present disclosure may be implemented by the cooperation of a client and/or a server.

As shown in FIG. 1, The method in this embodiment includes the steps below.

In S110, a target key video frame is determined.

A video is composed of a plurality of video frames. For example, in a real-time interactive application scenario, a key video frame may be determined in a real-time interactive process. A hot spot discussed at a current moment may be determined according to content corresponding to the key video frame, and thus a hot word is generated based on the discussed hot spot. Alternatively, in a non-real-time interactive application scenario (for example, an application scenario of determining a hot word based on a screen-recording video or an existing video), key video frames may be determined in sequence from an initial playing moment of the video, and thus the hot word is determined from the key video frames. Alternatively, a key video frame is determined when it is detected that a user triggers a control for starting to determine the hot word, and thus the hot word is determined based on the key video frame.

That is, in any application scenario, a key video frame in a target video may be determined from the initial playing moment. A video frame that is being processed currently is taken as the target key video frame.

It is to be noted that each video frame in the target video may be taken as the target key video frame. Alternatively, before a plurality of video frames in the target video are processed in sequence, it is determined based on some screening conditions whether a video frame is the target key video frame. Of course, if the processing efficiency of a processor is relatively high, each video frame in the target video may be taken as the target key video frame and processed.

In S120, a target region in the target key video frame is determined.

Each video frame may be, for example, a person's portrait, a shared web page, a shared screen, or other information. It is to be understood that each video frame has a corresponding layout. In order to acquire content in the target key video frame, at least one region in the target key video frame may be determined first. Thus corresponding identification and/or content may be acquired from each region, and target content may be determined based on the identification and/or content.

Exemplarily, after the target key video frame is determined, the at least one region in the target key video frame may be determined so that the corresponding target content is acquired from each region to determine a corresponding high-frequency word, that is, the hot word, based on the target content. The determination of the hot word helps to determine the core content of the video. Accordingly, in a speech-based conversion, a corresponding core word may be determined based on speech information to avoid the case of a wrong speech conversion, thus improving speech conversion efficiency.

In S130, target content in the target key video frame is determined based on the target region.

In this embodiment, the target region may be an address bar region and may also be a text box region. Of course, the target region may also be another region in the target key video frame. Content located in the target region may be taken as the target content. Here if the target key video frame represents a web page, a region representing a uniform resource locator (URL) address of the web page may be considered as an address bar region. Additionally, a text box region may be divided into at least one discrete text region according to a preset rule. The number of vertical pixels occupied by the height of a character in the text and the number of horizontal pixels occupied by each character in each line may be acquired. A discrete text region is determined according to the number of horizontal pixels and the number of vertical pixels. For example, the number of vertical pixels is 20, the number of horizontal pixels is also 20, and a discrete text region includes ten characters. In this case, the discrete text region may include 20×200 pixels; that is, the discrete text region is a 20×200 region.

In S140, a hot word of a target video to which the target key video frame belongs is determined by processing the target content.

The hot word may be understood as an issue and affair that users generally pay attention to in a certain period or node; that is, the hot word reflects a hot topic in a period. Such issues, affairs, and hot topics may be represented by using corresponding hot words. In this embodiment, if an application scenario is a video conference whose topic is a research and development project, the hot word may be a word used for a discussion on the research and development project in the video conference. That is, in this embodiment, the hot word may be understood as a word corresponding to a hot topic that interactive users generally discuss or pay attention to from a certain moment to a current moment in a video conference process or a live broadcast process. In order to improve the accuracy of determining the hot word so as to improve the conversion efficiency and accuracy in a speech-to-text process, the hot word corresponding to the video content may be dynamically generated and updated in the video conference process.

In this embodiment, the step in which the hot word corresponding to the target content is determined by processing the target content may include the following steps: First, word segmentation is performed on the target content to acquire at least one segmentation word; then each word vector of each segmentation word is determined, and an average vector is determined based on each word vector of the at least segmentation word; and then a target segmentation word in the target content is determined by determining each distance value between each word vector and the average word vector, and the determined target segmentation word is taken as the hot word.

According to technical solutions of embodiments of the present disclosure, by processing the target key video frame in the target video, at least one target region in the target key video frame may be determined, the target content in the target region may be acquired, and the hot word of the target video to which the target key video frame belongs is determined based on the target content to determine the core content discussed in the target video. Accordingly, the hot word corresponding to the speech information may be determined in a speech-to-text conversion, thus improving the accuracy and convenience of the speech-to-text conversion.

The method further includes the following steps: The speech information is collected when a control triggering the speech-to-text conversion is detected; and if the speech information includes the hot word, the corresponding hot word may be retrieved for performing the speech-to-text conversion, thus improving the accuracy and convenience of the speech-to-text conversion.

The method further includes that the target video is generated based on a real-time interactive interface to determine the target key video frame from the target video.

Technical solutions of embodiments of the present disclosure may be applied to a real-time interactive scenario, such as a video conference and a live broadcast. The real-time interactive interface is any interactive interface in the real-time interactive application scenario. The real-time interactive application scenario may be implemented by means of the Internet and a computer, for example, an interactive application program implemented through a native program, a web program, or the like. The target video is generated based on the real-time interactive interface. The target video may be a video corresponding to a video conference and may also be a live broadcast video. The target video is composed of a plurality of video frames from which the target key video frame may be determined. A video frame including a target identifier and in the target video is taken as the target key video frame. Accordingly, before the hot word corresponding to the target video is determined, the target key video frame in the target video may be determined first to determine the hot word according to the target key video frame.

The method further includes that in response to detecting a control triggering screen sharing, desktop sharing, or target video playing, a to-be-processed video frame in the target video is collected to determine the target key video frame from the to-be-processed video frame.

Optionally, when the control triggering sharing is detected, the to-be-processed video frame in the target video is collected; and the target key video frame is determined according to the similarity value between the to-be-processed video frame and at least one historical key video frame in the target video.

When the application scenario is a real-time interactive scenario, the sharing control may be a control corresponding to screen sharing or file sharing. The to-be-processed video frame may be a video frame including the target identifier and in the preset region. A historical key video frame is a determined video frame including the target identifier. After the to-be-processed video frame is determined, the target key video frame may be determined according to the similarity value between the to-be-processed video frame and each historical key video frame among the at least one historical key video frame. The target key video frame is a part of video frames in the target video. A processed video frame may be taken as the target key video frame.

It is to be noted that the case where repeated content is displayed in adjacent video frames is possible to exist in any application scenario. In order to mitigate the problem of a waste of resources due to the repeated processing of video frames with the same content, the target key video frame may be determined first before the target video is processed.

In this embodiment, an advantage of the step in which the target key video frame is determined according to each similarity value between the to-be-processed video frame and the at least one historical key video frame lies in the following aspect: The case of video playback exists in an actual application process. For example, a user uses a knowledge point of the previous video frames when talking about content in a current video frame. In this case, the user may return to content corresponding to the previous video frames. If the previous video frames are already determined as target key video frames, the current video frame may also be determined as the target key video frame in this case. In order to avoid the case where determined target key video frames are repeated, a plurality of historical key video frames may be acquired so that it is determined based on the similarity value between the historical key video frames and the current video frame whether the current video frame is the target key video frame, improving the accuracy of determining the target key video frame.

The method includes that at least one hot word is sent to a hot word cache module so that the corresponding hot word is extracted from the hot word cache module according to the speech information in the case where the triggering of a speech-to-text operation is detected.

The hot word cache module may be a module for storing hot words in the client or the server; that is, the hot word cache module is configured to store hot words determined in real time in the video conference process.

It is to be understood that after the hot word corresponding to the target video is determined, the hot word may be stored in the corresponding hot word cache module so that the hot word corresponding to the speech information may be acquired from a target position when the control triggering the speech-to-text conversion is detected, thus improving the accuracy and convenience of the speech-to-text conversion.

### Embodiment Two

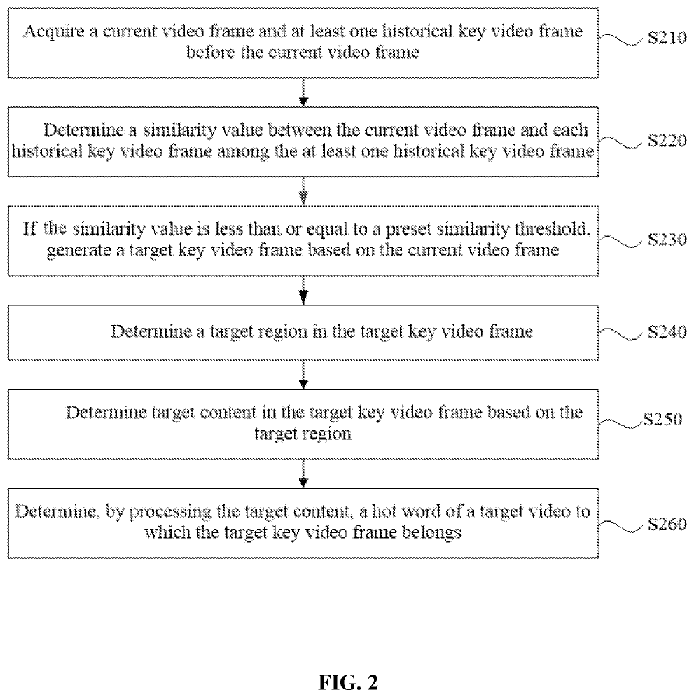

FIG. 2 is a flowchart of a hot word extraction method according to embodiment two of the present disclosure. On the basis of the preceding embodiment, the target key value frame may be determined according to the current video frame and at least one historical key video frame before the current video frame. Terms identical to or similar to the preceding embodiment are not repeated here.

As shown in FIG. 2, the method includes the steps below.

In S210, a current video frame and at least one historical key video frame before the current video frame are acquired.

It is to be noted that the case of repeated content in adjacent video frames may exist in each video. In order to avoid the problem of a waste of resources due to the processing of repeated video frames, before a plurality of video frames are processed in sequence, it may be determined whether the current video frame is similar to the previous key video frame so as to determine based on the similarity whether the current video frame is a target key video frame.

A historical key video frame refers to a key video frame determined before a current moment. Optionally, if the current video frame is a first video frame, no historical key video frame may exist, and the current video frame is taken as the target key video frame. After the next video frame of the current video frame is acquired, the current video frame may be taken as a video frame in the at least one historical key video frame. Solutions provided in embodiments of the present disclosure may be used for determining whether the next video frame is the target key video frame. Accordingly, a historical key video frame is a key video frame determined before the current video frame. If the current video frame is a key video frame, the current video frame may be taken as the target key video frame.

In S220, a similarity value between the current video frame and each historical key video frame among the at least one historical key video frame is determined.

It is to be noted that in order to avoid processing repeated video frames, after the current video frame is acquired, a previous key video frame or several previously determined key video frames may be processed so as to determine a similarity value between the current video frame and the previous key video frame or between the current video frame and the previous key video frames. Accordingly, it is determined based on the similarity value whether the current video frame is the target key video frame.

A similarity value is used for representing the similarity between the current video frame and a historical key video frame. The higher the similarity value, the greater the similarity between the current video frame and the historical key video frame and the higher the possibility of repeated video frames. The lower the similarity value, the greater the difference between the current video frame and the historical key video frame and the lower the possibility of repeated video frames.

Exemplarily, a series of calculation methods may be used for determining each similarity value between the current video frame and a preset number of historical key video frames so that it is determined based on each similarity value whether the current video frame is taken as the target key video frame.

In this embodiment, an advantage of the step in which the target key video frame is determined according to each similarity value between the to-be-processed video frame and the at least one historical key video frame lies in the following aspect: The case of video playback exists in an actual application process. For example, a user uses a knowledge point of the previous video frames when talking about content in the current video frame. In this case, the user may return to content corresponding to the previous video frames. If the previous video frames are already determined as target key video frames, the current video frame may also be determined as the target key video frame in this case. In order to avoid the case where determined target key video frames are repeated, a plurality of historical key video frames may be acquired so that it is determined based on each similarity value between the historical key video frames and the current video frame whether the current video frame is the target key video frame, improving the accuracy of determining the target key video frame.

In S230, if the similarity value is less than or equal to a preset similarity threshold, the target key video frame is generated based on the current video frame.

The preset similarity threshold may be preset and used for defining whether the current video frame is taken as the target key video frame.

Exemplarily, if a similarity value is less than or equal to the preset similarity threshold, it indicates that the difference between the current video frame and a historical key video frame is relatively great; that is, a coincidence degree between the current video frame and the historical key video frame is relatively low. The current video frame may be taken as the target key video frame.

In S240, a target region in the target key video frame is determined.

In S250, target content in the target key video frame is determined based on the target region.

In S260, a hot word of a target video to which the target key video frame belongs is determined by processing the target content.

According to technical solutions of embodiments of the present disclosure, the similarity value between the current video frame and each historical key video frame is determined so as to determine whether the current video frame is the target key video frame, avoiding the problem of a waste of resources due to the processing of all video frames and implementing the processing for limited video frames. Accordingly, the hot word of the video to which the video frame belongs is determined so that the hot word corresponding to speech information is determined in the speech-to-text processing, thus improving the accuracy and convenience of a speech-to-text conversion.

Embodiment Three

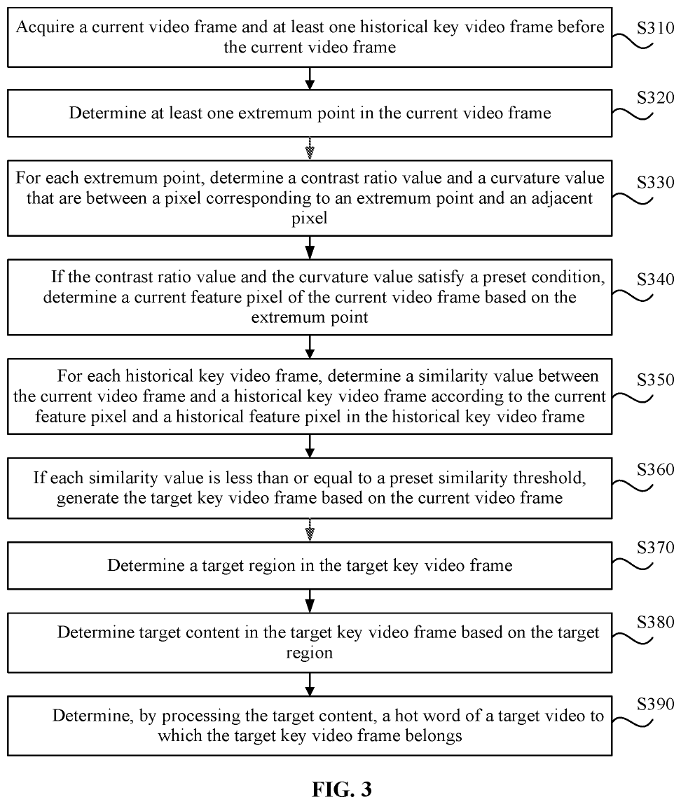

FIG. 3 is a flowchart of a hot word extraction method according to embodiment three of the present disclosure. On the basis of the preceding embodiments, the target key video frame is determined based on the similarity value between the current video frame and each historical key video frame. For the determination of the similarity value between the current video frame and each historical key video frame, reference may be made to technical solutions provided in this embodiment. Terms identical to or similar to the preceding embodiments are not repeated here.

As shown in FIG. 3, the method includes the steps below.

In S310, a current video frame and at least one historical key video frame before the current video frame are acquired.

In S320, at least one extremum point in the current video frame is determined.

It is to be noted that before it is determined whether the current video frame is a target key video frame, difference of Gaussians may be established for the current video frame so that the current video frame is divided into at least two layers. An example is taken in which a certain pixel in one of the layers is taken as a target pixel. A pixel adjacent to the target pixel is acquired and taken as a to-be-determined pixel. The to-be-determined pixel includes not only a pixel in a layer to which the target pixel belongs but also a pixel in a layer adjacent to the layer to which the target pixel belongs. That is, the divided difference of Gaussians may be understood as a spatial structure. The to-be-determined pixel is a pixel adjacent to the target pixel in space. If a value corresponding to the target pixel (for example, a pixel value of the target pixel) is greater than values corresponding to all to-be-determined pixels, the target pixel may be taken as an extremum point. In this manner, the at least one extremum point in the current video frame may be determined in sequence.

The number of the at least one extremum point may be at least one. The number may be determined according to a processing result. An extremum point set of the current video frame may be determined according to the determined at least one extremum point.

In S330, for each extremum point, a contrast ratio value and a curvature value that are between a pixel corresponding to an extremum point and an adjacent pixel are determined.

For each extremum point in the extremum point set, a pixel corresponding to an extremum point may be determined. By comparing a contrast ratio value and a curvature value that are between the pixel of the extremum point and an adjacent pixel, it may be determined whether the pixel is a current feature pixel. Accordingly, it is determined based on the determined current feature pixel whether the current video frame is the target key value frame. The contrast ratio value may be understood as a relative value. For an image, the contrast ratio value reflects a ratio of the brightest part of the image to the darkest part of the image. In this embodiment, the contrast ratio value may be a brightness ratio of the pixel corresponding to the extremum point to the adjacent pixel.

Exemplarily, for each extremum point, a pixel corresponding to an extremum point may be determined; moreover, a curvature value of the pixel and a contrast ratio value of the pixel are determined.

In S340, if the contrast ratio value and the curvature value satisfy a preset condition, the current feature pixel of the current video frame is determined based on the extremum point.

The preset condition is preset and used for representing whether the pixel corresponding to the extremum point may be taken as the current feature pixel. The current feature pixel may be understood as a pixel representing the current video frame. After the contrast ratio value corresponding to the extremum point and the curvature value corresponding to the extremum point are determined, it may be determined based on a relationship between the contrast ratio value and curvature value and the preset condition whether the current video frame is the current feature pixel.

Exemplarily, if the contrast ratio value and the curvature value satisfy the preset condition, the pixel corresponding to the extremum point may be taken as the current feature pixel of the current video frame. If one of the contrast ratio value or the curvature value does not satisfy the preset condition, it indicates that the pixel corresponding to the extremum point is not the current feature pixel; that is, the pixel corresponding to the extremum point cannot represent the current video frame.

In S350, for each historical key video frame, a similarity value between the current video frame and a historical key video frame is determined according to the current feature pixel and a historical feature pixel in the historical key video frame.

It is to be noted after the current feature pixel corresponding to the current video frame is determined, the similarity value between the current video frame and the historical key video frame may be determined according to the current feature pixel.

It is to be further noted that in order to avoid the case of video content playback in a video process, a preset number of historical key video frames may be acquired to determine the similarity with the current video frame. Optionally, three historical key video frames may be included.

The historical feature pixel is a feature pixel that is in the historical key video frame and may represent the video frame. In order to be distinguished from a feature pixel in the current video frame, the feature pixel in the historical key video frame may be taken as the historical feature pixel. The feature pixel in the current video frame is taken as the current feature pixel.

Exemplarily, for each historical key video frame, a current feature pixel in a current video frame and a historical feature pixel in a historical key video frame are acquired. The similarity value between the current video frame and the historical key video frame is determined by processing the current feature pixel and the historical feature pixel. The similarity value between each of a preset number of historical key video frames and the current video frame is calculated in sequence by using the preceding manner so as to determine based on the similarity value whether the current video frame is the target key video frame.

In this embodiment, the step in which the similarity value between the current video frame and the historical key video frame is determined according to the current feature pixel and the historical feature pixel in the historical key video frame includes the following steps: Each current feature vector corresponding to each current feature pixel and the historical feature vector corresponding to the historical feature pixel are determined; a target transformation matrix between the current video frame and the historical key video frame is generated based on a current feature vector and the historical feature vector; and the similarity value between the current video frame and the historical key video frame is determined based on the target transformation matrix, the current video frame, and the historical key video frame.

It is to be noted that after at least one feature pixel is determined, for each feature pixel, a gradient of a feature pixel and a direction of the feature pixel may be calculated. A main direction of the feature pixel is determined based on the gradient and the direction. According to the main direction of the feature pixel, an image of a surrounding region may be determined by rotating each feature pixel. A gradient histogram of the surrounding region of the feature pixel is calculated to serve as a feature vector of the feature pixel. Moreover, the feature vector is normalized to acquire a current feature vector corresponding to the current feature pixel. Each current feature vector corresponding to each current feature pixel in the current video frame is determined in sequence by using the preceding manner. Meanwhile, the historical feature vector corresponding to the historical feature pixel in the historical key video frame is acquired.

The target transformation matrix is determined based on the current feature vector and the historical feature vector. The current video frame may be converted based on the target transformation matrix to acquire a converted video frame. The similarity value between the current video frame and the historical key video frame may be determined according to the converted video frame and the historical key video frame.

Exemplarily, each current feature vector corresponding to each current feature pixel is determined. The historical feature vector corresponding to the historical feature pixel in a historical video frame is acquired. The target transformation matrix between the current video frame and the historical key video frame is determined by calculating a distance value between the current feature vector and the historical feature vector. The similarity value between the current video frame and the historical key video frame may be determined based on the target transformation matrix.

In this embodiment, the step in which the target transformation matrix between the current video frame and the historical key video frame is generated based on the current feature vector and the historical feature vector may be as follows: A current feature vector set is determined based on at least one current feature vector, and a historical feature vector set is determined based on the historical feature vector of the historical key video frame; for each current feature vector in the current feature vector set, each distance value between a current feature vector and each historical feature vector in the historical feature vector set is determined; a historical feature vector corresponding to the current feature vector is determined based on a distance value; and the target transformation matrix between the current video frame and the historical key video frame is determined based on each historical feature vector corresponding to the at least one current feature vector.

In order to clearly introduce technical solutions of embodiments of the present disclosure, an example may be taken in which a similarity value between the current video frame and one historical key video frame is judged.

The distance value may be the similarity value between the current feature vector and the historical feature vector. In order to determine each historical feature vector corresponding to each current feature vector, each distance value between a current feature vector and each historical feature vector may be calculated. A historical feature vector corresponding to the smallest distance value is taken as the historical feature vector corresponding to the current feature vector. Each historical feature vector corresponding to each current feature vector of the current video frame is determined in sequence in such a manner. After each historical feature vector corresponding to each current feature vector is determined, an optimal single mapping matrix may be calculated and taken as a transformation matrix.

It is to be noted that at least one transformation matrix may be determined based on the current video frame and the historical key video frame. A ratio of the number of current feature vectors to the number of historical feature vectors may be determined based on the at least one transformation matrix. A transformation matrix corresponding to the highest ratio is taken as the target transformation matrix.

After the target transformation matrix is acquired, the similarity value between the current video frame and the historical key video frame may be determined based on the target transformation matrix. Optionally, the ratio of the number of current feature vectors to the number of historical feature vectors in the historical key video frame is determined based on the target transformation matrix, and the similarity value between the current video frame and the historical key video frame is determined based on the ratio.

Exemplarily, a conversion may be processed for each current feature vector based on the target transformation matrix. The ratio of the current feature vectors to the historical feature vectors may be determined based on a conversion processing result. The ratio may be taken as the similarity value between the current video frame and the historical key video frame.

In S360, if the similarity value is less than or equal to a preset similarity threshold, the target key video frame is generated based on the current video frame.

In S370, a target region in the target key video frame is determined.

In S380, target content in the target key video frame is determined based on the target region.

In S390, a hot word of a target video to which the target key video frame belongs is determined by processing the target content.

According to technical solutions of embodiments of the present disclosure, for each historical key video frame, a pixel in the current video frame and a corresponding pixel in a historical key video frame may be processed. The similarity value between the current video frame and the historical key video frame may be determined based on a processing result. Accordingly, it is determined whether the current video frame is the target key video frame, improving the accuracy of determining the target key video frame.

### Embodiment Four

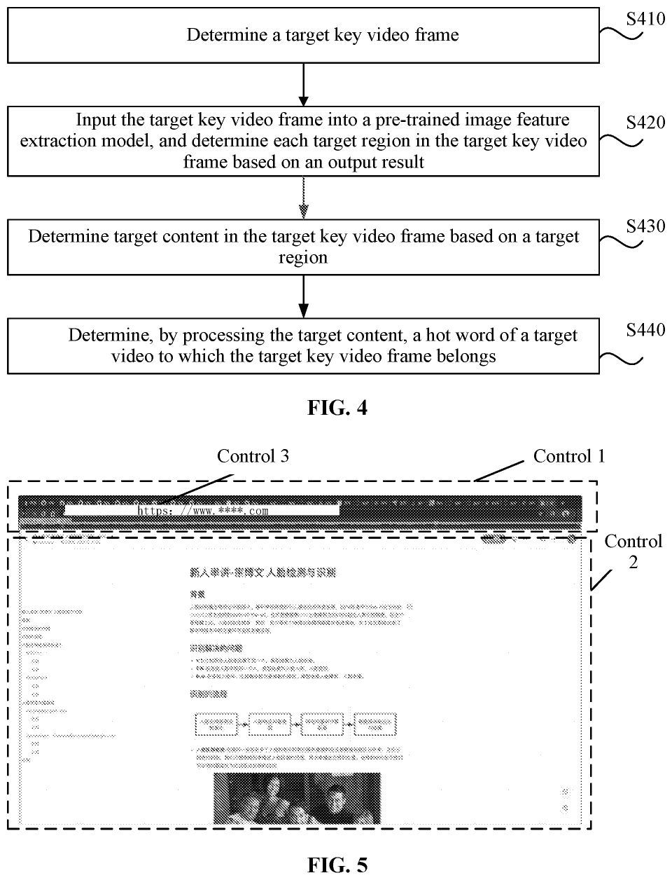

FIG. 4 is a flowchart of a hot word extraction method according to embodiment four of the present disclosure. On the basis of the preceding embodiments, for the determination of at least one target region in the target key video frame, reference may be made to this embodiment. Terms identical to or similar to the preceding embodiments are not repeated here.

As shown in FIG. 4, the method includes the steps below.

In S410, a target key video frame is determined.

In S420, the target key video frame is input into a pre-trained image feature extraction model, and at least one target region in the target key video frame is determined based on an output result.

The image feature extraction model is acquired by pre-training and is configured to process the input target key video frame and determine at least one region in the target key video frame, for example, an address bar region and a text box region.

It is to be noted that when a speaker shares a screen or a file, the shared page may include the address bar region and the text box region. The address bar region may display a link to the shared page. The text box region may display corresponding text content. In order to acquire content in a corresponding region, the at least one target region in the target key video frame may be determined first so that target content is acquired from the at least one target region.

Exemplarily, the target video frame is input into the pre-trained image feature extraction model. The image feature extraction model may output a matrix. The at least one target region in the target key video frame may be determined based on a value of the matrix.

Optionally, the at least one target region includes a target address bar region. The step in which the at least one target region in the target key video frame is determined based on the output result includes the following steps: The association information of the target key video frame is determined based on the output result; and the target address bar region in the target key video frame is determined based on the association information.

The output result is a matrix corresponding to the target key video frame. The association information of the target key video frame may be determined based on the matrix. The association information includes the coordinate information of an address bar region in the target key video frame, the foreground confidence information, and the confidence information of an address bar. Confidence information may be understood as credibility. Correspondingly, the foreground confidence information may be the reliability that the region is a foreground. The confidence information of an address bar may be the reliability that the region is an address bar. The determined address bar region may be taken as the target address bar region. The target address bar region in the target key video frame may be determined according to the association information in the output result.

That is, the target key video frame is input into the image feature extraction model so that an image feature map may be extracted. That is, the matrix corresponding to the target key video frame is extracted. A candidate region may be calculated based on the image feature map. That is, the association information corresponding to the target key video frame may be determined based on the image feature map. According to region coordinates, foreground confidence, and category confidence that are in the association information, optionally, the category confidence includes, for example, address bar confidence and text confidence. The at least one target region in the target key video frame may be determined based on the preceding association information. Optionally, a target region may be a target address bar region.

Exemplarily, referring to FIG. 5, after the target key video frame is input into the image feature extraction model, the output result is acquired. The target address bar region in the target key video frame, the target text region in the target key video frame, and the confidence of a URL address in the target address bar region may be determined based on the output result. For example, control 1 corresponds to the address bar region predicted based on the output result, control 2 corresponds to the text box region predicted based on the output result, and control 3 corresponds to the predicted URL address. It is to be noted that since the URL address must appear in the address bar, the target address bar region with the highest foreground confidence in the address bar may be reserved. Of course, a target text box region in the target key video frame may be determined based on the output result.

On the basis of the preceding embodiment, after the target text box region is acquired, it is also necessary to acquire at least one text line region in a target text box. Moreover, the corresponding text content is acquired from the at least one text line region, thus improving the accuracy and convenience of determining the text content in a text box.

Optionally, the association information of the target key video frame is determined based on the output result. The target text box region in the target key video frame is determined based on the association information. The association information includes the position coordinate information of a text box region in the target key video frame, the foreground confidence information in the target key video frame, and the confidence information of the text box region.

After the target text box region in the target key video frame is acquired, a corresponding text line region may be acquired from the target text box region so that the corresponding text content is acquired from each text line region. Accordingly, a hot word of a video to which the target key video frame belongs may be determined based on the text content. In this case, in the speech-to-text conversion, if pinyin corresponding to the hot word exists, a conversion may be performed, improving the efficiency and accuracy of the text conversion.

In this embodiment, to determine a text character region in the target key video frame, all text character regions in the target key video frame may be determined first. Then a text character region in the text box region is determined according to the determined text box region, and thus content in the text character region is determined.

Optionally, the target key video frame is processed based on a text line extraction model, and a first feature matrix corresponding to the target key video frame is output; at least one discrete text character region including character content and in the target key video frame is determined based on the first feature matrix, where the first feature matrix includes the coordinate information and the foreground confidence information of a discrete text character region; at least one to-be-determined text line region in the discrete text character region is determined according to preset text character line spacing; and a target text line region in the target key video frame is determined based on the target text box region and the at least one to-be-determined text line region.

The text line extraction model is acquired by pre-training and is configured to process the input target key video frame and determine a text character region in the target key video frame based on the output result. The text character region may be understood as a region including text and in the target key video frame. The first feature matrix is a result output by the text line extraction model. A plurality of values in the first feature matrix may represent the text character regions in the target key video frame. That is, the first feature matrix includes the coordinate information of a text character region and the foreground confidence information. The text character line spacing is preset. In this embodiment, the text character line spacing mainly represents a horizontal distance between discrete text character regions, that is, the number of discrete text regions included in one line. The text character line spacing is used for determining each line position of each text character region after the at least one discrete text character region in the target key video frame is determined. That is, each line where each discrete text character region is located in the target key video frame and each position where each discrete text character region is located in each text character region are determined. A to-be-determined text line region includes at least one discrete text character region that is located in the same line in the text line region.

It is to be noted that since the pre-trained text line extraction model is acquired by training discrete text, a discrete text character region may be predicted based on the output result.

Exemplarily, the target key video frame is input into the text line extraction model to acquire the first feature matrix corresponding to the target key video frame. At least one discrete text region in the target key video frame may be determined based on the coordinate information of a discrete text region in the first feature matrix and the foreground confidence information. To determine the number of lines where each discrete text region is located in the target key video frame, the number of lines where a discrete text character region is located may be determined according to the preset text line spacing. The at least one text line region located in the target text box region may be determined based on the coordinate information of the discrete text character region, the lines of the discrete text character region, and the coordinate information of the pre-determined target text box region. A determined text line region may be taken as the target text line region.

Optionally, the step in which the target text line region in the target key video frame is determined based on the target text box region and the at least one to-be-determined text line region includes the following step: The target text line region is determined from all of the at least one to-be-determined text line region based on the at least one to-be-determined text line region in the target text box region and an image resolution of a to-be-determined text line region.

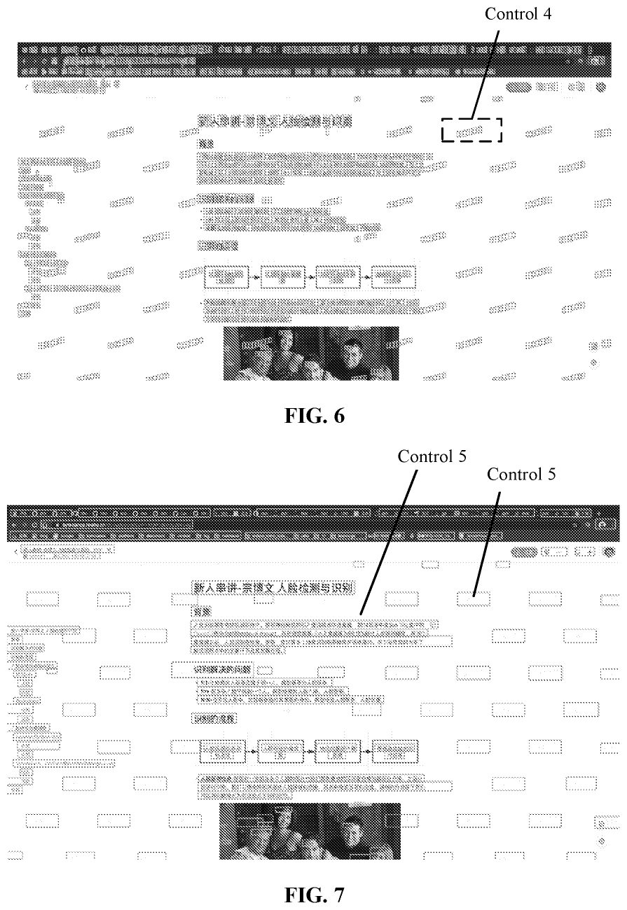

Exemplarily, the target key video frame is input into the text line extraction model. The first feature matrix of the target key video frame may be acquired by processing the target key video frame based on the text line extraction model. The at least one discrete text character region of the target key video frame may be determined according to the discrete text coordinate information and the foreground confidence information in the first feature matrix. As shown in FIG. 6, a region corresponding to control 4 in the figure is a text character region. To improve the accuracy of recognizing the text region, a label with a width of 8 pixels may be used to fit the text region. Accordingly, the text character region acquired based on the first feature matrix is also a discrete text character region. After the at least one discrete text region is acquired, in order to determine content located in the same line, at least one to-be-determined text line region in a discrete text character region may be determined according to the preset text line spacing. That is, a discrete text region located in the same line in discrete text is determined. Moreover, a discrete text character region, for example, control 1 in FIG. 7, located in the same line is taken as a text line region. The target text line region may be determined according to the predetermined target text box region and the coordinate information of the at least one to-be-determined text line region.

In order to prevent the existence of other content information in the determined target text line region from causing a low processing efficiency when extracted target content is processed, the step in which the target text line region in the target key video frame is determined based on the target text box region and the at least one to-be-determined text line region includes the following step: The target text line region is determined from all of the at least one to-be-determined text line region based on the at least one to-be-determined text line region in the target text box region and an image definition of a to-be-determined text line region.

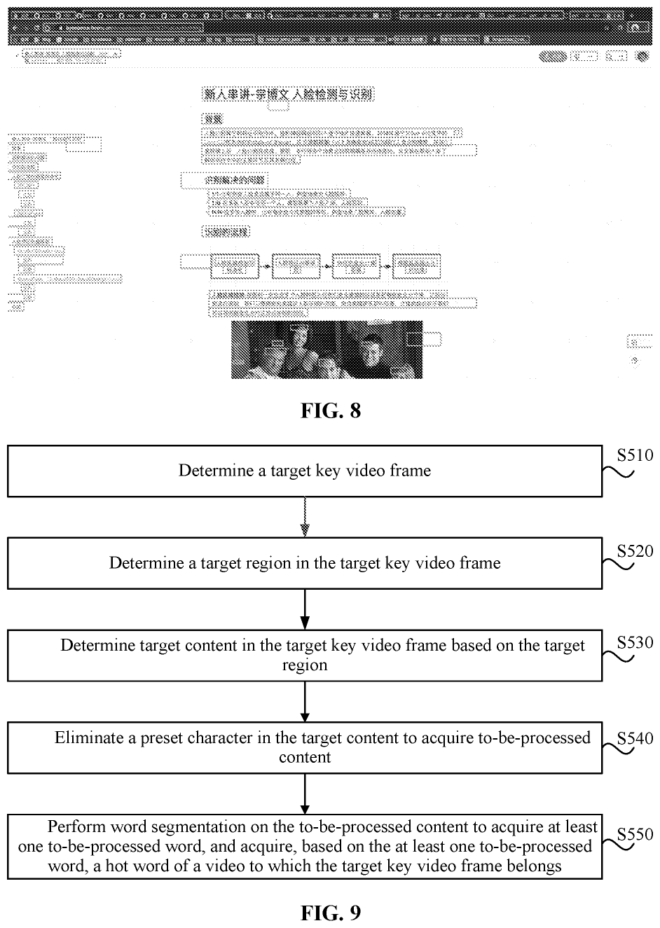

Exemplarily, referring to FIG. 8, a background watermark exists in the target key video frame. To avoid processing such content, a discrete text character region with a relatively high image resolution is reserved based on a contrast ratio of a discrete text character region in the at least one to-be-determined text line region in a text line region. Such an arrangement has an advantage of rapidly determining an effective discrete text character region in the target key video frame, thereby acquiring the corresponding text content. That is, discrete text character region with a definition may be reserved.

On the basis of the preceding technical solutions, it is to be noted that to improve the recognition accuracy of determining the text region, a label with a width of 8 pixels may be used to fit the text region. Accordingly, the text line extraction model is also acquired by training the training sample data fitted based on the 8 pixels.

Optionally, the determination of the text line extraction model includes the following steps: The training sample data is acquired, where the at least one discrete character region in the video frame, coordinates of a character region, and confidence of the character region are pre-marked in the training sample data, and the character region is a region determined through the fitting based on a preset number of pixels; a to-be-trained text line extraction model is trained based on the training sample data to acquire a training feature matrix corresponding to the training sample data; processing is performed based on a loss function, a standard feature matrix in the training sample data, and the training feature matrix, and a model parameter in the to-be-trained text line extraction model is corrected based on a processing result; and a loss function convergence is taken as a training target to acquire the text line extraction model through training.

To improve the accuracy of the model, the training sample data may be acquired as much as possible. Each training sample data includes a discrete text character region and coordinates of a text character region. The text character region is a region determined through the fitting based on a preset number of pixels. Accordingly, for the model trained and acquired based on the training sample data, the output result also includes information including the coordinates of the text character region and the discrete text character region.

It is to be noted that before the to-be-trained text line extraction model is trained, a training parameter of the to-be-trained text line extraction model may be set to a default value; that is, the model parameter is set to the default value. When the to-be-trained text line extraction model is trained, the training parameter in the model may be corrected based on the output result of the to-be-trained text line extraction model; that is, the training parameter in the to-be-trained text line extraction model may be corrected based on the preset loss function to acquire the text line extraction model.

Exemplarily, the training sample data may be input into the to-be-trained text line extraction model to acquire the training feature matrix corresponding to the training sample data. A loss value between the standard feature matrix and the training feature matrix may be calculated based on the standard feature matrix in the training sample data and the training feature matrix. The model parameter in the to-be-trained text line extraction model is determined based on the loss value. A training error of the loss function, that is, a loss parameter, is taken as a condition for detecting whether the loss function reaches the convergence currently, for example, whether the training error is smaller than a preset error, whether an error changing trend tends to be stable, or whether the current number of iterations is equal to a preset number. When the detection reaches the convergence condition, for example, when the training error of the loss function reaches or is smaller than the preset error or when the changing trend tends to be stable, it indicates that the training of the to-be-trained text line extraction model is completed. In this case, iterative training may be stopped. If it is detected that the convergence condition is not satisfied currently, the sample data may be acquired to train the to-be-trained text line extraction model until the training error of the loss function is within a preset range. When the training error of the loss function reaches convergence, the to-be-trained text line extraction model may be taken as the text line extraction model.

In this embodiment, the arrangement of the text line extraction model has an advantage of rapidly and accurately determining a discrete text character region in the target key video frame, thus improving the accuracy of acquiring the text content.

In S430, target content in the target key video frame is determined based on a target region.

In S440, a hot word of a target video to which the target key video frame belongs is determined by processing the target content.

According to technical solutions of embodiments of the present disclosure, the target text line region in the target key video frame may be determined by inputting the target key video frame into the text line extraction model, thus acquiring the corresponding target content to improve the accuracy and convenience of determining the target content.

### Embodiment Five

FIG. 9 is a flowchart of a hot word extraction method according to embodiment five of the present disclosure. On the basis of the preceding embodiments, the step in which “a hot word of a target video to which the target key video frame belongs is determined by processing the target content” may be refined. Terms identical to or similar to the preceding embodiments are not repeated here.

As shown in FIG. 9, the method includes the steps below.

In S510, a target key video frame is determined.

In S520, a target region in the target key video frame is determined.

In S530, target content in the target key video frame is determined based on the target region.

In this embodiment, if the target region is a target address bar region, corresponding content may be acquired based on a URL address in an address bar region to be taken as the target content. If the target region is a target text box region, a text line region in a text box region and corresponding text content may be determined; moreover, the determined text content may be taken as the target content. An advantage of determining the target content in this manner lies in that the text content may be acquired as much as possible. Accordingly, a hot word of a video to which the target key video frame belongs is determined based on the text content.

In S540, a preset character in the target content is eliminated to acquire to-be-processed content.

It is to be noted that the text content acquired based on the URL address or an image and text recognition may be directly taken as the target content. In order to improve the efficiency of determining the hot word, the target content may be processed again to acquire the valid content of the target content so that the hot word is determined based on the valid content to improve the efficiency of determining the hot word.

Content corresponding to the target content with the preset character eliminated may be taken as the to-be-processed content. The preset character may be content having no actual meaning, for example, “of”.

In S550, word segmentation is performed on the to-be-processed content to acquire at least one to-be-processed word, and the hot word of the video to which the target key video frame belongs is acquired based on the at least one to-be-processed word.

The to-be-processed content may be divided into the at least one to-be-processed word based on a preset word segmentation tool, such as JIEBA (that is, stutter), or another preset word segmentation model.

Exemplarily, the to-be-processed content is divided into the at least one to-be-processed word through the preset word segmentation tool to determine the hot word of the video to which the target key video frame belongs.

In this embodiment, the step in which the hot word of the video to which the target key video frame belongs is acquired based on the at least one to-be-processed word includes the following steps: An average word vector corresponding to all of the at least one to-be-processed word is determined; for each to-be-processed word, a distance value between each word vector of each to-be-processed word and the average word vector is determined; and it is determined that a to-be-processed word corresponding to a word vector with the smallest distance value from the average word vector serves as a target to-be-processed word, and the hot word of the target key video frame is generated based on the target to-be-processed word.

Optionally, after the target content is acquired, a character symbol such as a character and English in the target content is eliminated. A Chinese character is retained to acquire the to-be-processed content. The at least one to-be-processed word corresponding to the to-be-processed content may be determined by performing the word segmentation on the to-be-processed content. When the number of to-be-processed words is greater than or equal to the preset number, the average word vector of all the to-be-processed words may be calculated in a clustering manner. Each distance value between the word vector of each to-be-processed word and the average word vector may be calculated in sequence. At least one to-be-processed word with the smallest distance value is taken as the target to-be-processed word. Based on the target to-be-processed word, the hot word of the video to which the target key video frame belongs is generated.

According to technical solutions of embodiments of the present disclosure, at least one word with a high association degree in the target content may be extracted by processing the target content. Such a word is taken as the hot word. Accordingly, if a character corresponding to speech information exists in the speech-to-text processing, a replacement may be performed based on the corresponding hot word, improving the accuracy and convenience of a speech-to-text conversion.

### Embodiment Six

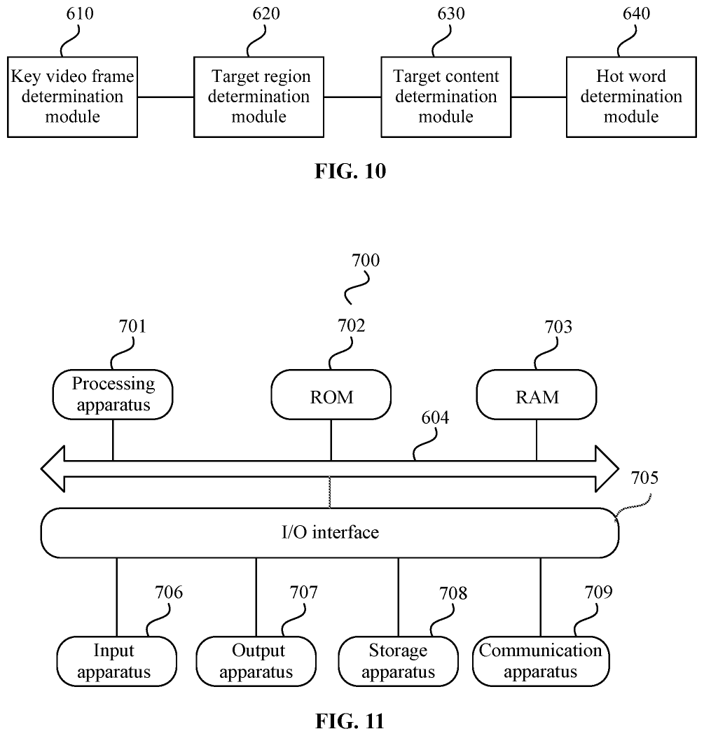

FIG. 10 is a diagram illustrating the structure of a hot word extraction apparatus according to embodiment six of the present disclosure. As shown in FIG. 10, the apparatus includes a key video frame determination module 610, a target region determination module 620, a target content determination module 630, and a hot word determination module 640.

The key video frame determination module 610 is configured to determine a target key video frame. The target region determination module is configured to determine at least one target region in the target key video frame based on the target key video frame. The target content determination module is configured to determine target content in the target key video frame based on a target region. The hot word determination module is configured to determine, by processing the target content, a hot word of the target key video frame.

According to technical solutions of embodiments of the present disclosure, the hot word corresponding to the target video may be determined dynamically by processing a plurality of target key video frames in the target video. Accordingly, when a speech-to-text conversion is implemented, the corresponding hot word is determined based on speech information to improve the accuracy and convenience of the speech-to-text conversion.

Optionally, the key video frame determination module includes a historical key video frame acquisition unit, a similarity value determination unit, and a target key video frame determination unit.

The historical key video frame acquisition unit is configured to acquire a current video frame and at least one historical key video frame before the current video frame.

The similarity value determination unit is configured to determine each similarity value between the current video frame and each historical key video frame among the at least one historical key video frame.

The target key video frame determination unit is configured to, if the similarity value is less than or equal to a preset similarity threshold, generate the target key video frame based on the current video frame.

Optionally, the apparatus further includes a video generation module configured to generate the target video based on a real-time interactive interface to determine the target key video frame from the target video.

Optionally, the apparatus further includes a sharing detection module configured to, in response to detecting a control triggering screen sharing, desktop sharing, or target video playing, collect a to-be-processed video frame in the target video to determine the target key video frame from the to-be-processed video frame.

Optionally, the target region determination module is configured to input the target key video frame into a pre-trained image feature extraction model and determine the at least one target region in the target key video frame based on an output result.

Optionally, the at least one target region includes a target address bar region. The target region determination module is configured to determine the association information of the target key video frame based on the output result and determine the target address bar region in the target key video frame on the association information. The association information includes the coordinate information of an address bar region in the target key video frame, the foreground confidence information, and the confidence information of an address bar.

Optionally, the target content determination module is configured to acquire a target URL address from the target address bar region to acquire the target content based on the target URL address.

Optionally, the at least one target region includes a target text box region. The target region determination module is configured to determine the association information of the target key video frame based on the output result and determine the target text box region in the target key video frame based on the association information. The association information includes the position coordinate information of a text box region in the target key video frame, the foreground confidence information, and the confidence information of the text box region.

Optionally, the target region determination module is configured to perform the following steps: The target key video frame is processed based on a text line extraction model, and a first feature matrix corresponding to the target key video frame is output; at least one discrete text character region including character content and in the target key video frame is determined based on the first feature matrix, where the first feature matrix includes the coordinate information of a discrete text character region and the foreground confidence information; at least one to-be-determined text line region in the discrete text character region is determined according to preset text character line spacing; and a target text line region in the target key video frame is determined based on the target text box region and the at least one to-be-determined text line region.

Optionally, the target region determination module is configured to determine the target text line region from all of the at least one to-be-determined text line region based on the at least one to-be-determined text line region in the target text box region and an image resolution of a to-be-determined text line region.

Optionally, the apparatus further includes a training text line model module configured to determine the text line extraction model. The determination of the text line extraction model includes the following steps: Training sample data is acquired, where the at least one discrete text character region in the video frame, coordinates of a text character region, and confidence of the text character region are pre-marked in the training sample data, and the text character region is a discrete region segmented from a continuous text line region; a to-be-trained text line extraction model is trained based on the training sample data to acquire a training feature matrix corresponding to the training sample data; processing is performed based on a loss function, a standard feature matrix in the training sample data, and the training feature matrix, and a model parameter in the to-be-trained text line extraction model is corrected based on a processing result; and a loss function convergence is taken as a training target to acquire the text line extraction model through training.

Optionally, the target content determination module is configured to extract a character in the target text line region based on image recognition technology and take the text as the target content.

Optionally, the hot word determination module is configured to eliminate a preset character in the target content to acquire to-be-processed content, to perform word segmentation on the to-be-processed content to acquire at least one to-be-processed word, and to acquire, based on the at least one to-be-processed word, the hot word of the video to which the target key video frame belongs.

Optionally, the hot word determination module is configured to perform the following steps: An average word vector corresponding to all of the at least one to-be-processed word is determined; for each to-be-processed word, a distance value between each word vector of each to-be-processed word and the average word vector is determined; and it is determined that a to-be-processed word corresponding to a word vector with the smallest distance value from the average word vector serves as a target to-be-processed word, and the hot word of the target key video frame is generated based on the target to-be-processed word.

Optionally, the apparatus further includes a hot word storage module configured to send at least one hot word to a hot word cache module so that a corresponding hot word is extracted from the hot word cache module according to speech information in the case where the triggering of a speech-to-text operation is detected.

The hot word extraction apparatus according to embodiments of the present disclosure can perform the hot word extraction method according to any embodiment of the present disclosure and has functional modules corresponding to the performed method.

It is to be noted that units and modules included in the preceding apparatus are divided according to function logic but are not limited to such division, as long as the corresponding functions can be achieved. Moreover, the specific names of function units are used for distinguishing between each other and not intended to limit the scope of the embodiments of the present disclosure.

### Embodiment Seven

FIG. 11 is a diagram illustrating the structure of an electronic device 700 (such as a terminal device or a server in FIG. 11) applicable to implementing embodiments of the present disclosure. The terminal device in embodiments of the present disclosure may include, but is not limited to, mobile terminals such as a mobile phone, a laptop, a digital broadcast receiver, a personal digital assistant (PDA), a portable Android device (PAD), a portable media player (PMP), and an in-vehicle terminal (such as an in-vehicle navigation terminal) and stationary terminals such as a digital television (TV) and a desktop computer. The electronic device shown in FIG. 11 is merely an example and should not impose any limitation to the function and usage scope of embodiments of the present disclosure.

As shown in FIG. 11, the electronic device 700 may include a processing apparatus (such as a central processing unit or a graphics processing unit) 701. The processing apparatus 701 may perform various proper actions and processing according to a program stored in a read-only memory (ROM) 702 or a program loaded into a random-access memory (RAM) 703 from a storage apparatus 708. Various programs and data required for the operation of the electronic device 700 are also stored in the RAM 703. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope, an output apparatus 707 including, for example, a liquid crystal display (LCD), a speaker, and a vibrator, the storage apparatus 708 including, for example, a magnetic tape and a hard disk, and a communication apparatus 709.

The communication apparatus 709 may allow the electronic device 700 to perform wireless or wired communication with other devices to exchange data. Although FIG. 11 shows the electronic device 700 having various apparatuses, it is to be understood that it is not required to implement or have all the shown apparatuses. Alternatively, more or fewer apparatuses may be implemented or present.

Particularly, according to embodiments of the present disclosure, the process described above with reference to a flowchart may be implemented as a computer software program. For example, a computer program product is included in embodiments of the present disclosure. The computer program product includes a computer program carried in a non-transitory computer-readable medium. The computer program includes program codes for executing the method shown in the flowchart. In such an embodiment, the computer program may be downloaded from a network and installed through the communication apparatus 709, or may be installed from the storage apparatus 706, or may be installed from the ROM 702. When the computer program is executed by the processing apparatus 701, the preceding functions defined in the methods in embodiments of the present disclosure are implemented.

The electronic device provided in embodiments of the present disclosure and the hot word extraction method provided in the preceding embodiments belong to the same concept. For technical details not described in this embodiment, reference may be made to the preceding embodiments.

### Embodiment Eight

Embodiments of the present disclosure provide a computer storage medium storing a computer program. When the computer program is executed by a processor, the hot word extraction method provided in the preceding embodiments is performed.

It is to be noted that the preceding computer-readable medium in the present disclosure may be a computer-readable signal medium or a computer-readable storage medium or any combination thereof. For example, the computer-readable storage medium may be, but is not limited to, an electrical, magnetic, optical, electromagnetic, infrared or semiconductor system, apparatus or device, or any combination thereof. Specifically, the computer-readable storage medium may include, but is not limited to, an electrical connection having one or more wires, a portable computer disk, a hard disk, a random access memory (RAM), a read-only memory (ROM), an erasable programmable read-only memory (EPROM) or flash memory, an optical fiber, a portable compact disc read-only memory (CD-ROM), an optical memory device, a magnetic memory device, or any suitable combination thereof. In the present disclosure, the computer-readable storage medium may be any tangible medium including or storing a program. The program may be used by or used in conjunction with an instruction execution system, apparatus, or device. In the present disclosure, the computer-readable signal medium may include a data signal propagated on a baseband or as a part of a carrier, and computer-readable program codes are carried in the data signal. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable signal medium may send, propagate, or transmit a program used by or used in conjunction with an instruction execution system, apparatus, or device. The program codes included on the computer-readable medium may be transmitted by any suitable medium, including, but not limited to, a wire, an optical cable, a radio frequency (RF), or any suitable combination thereof.

In some embodiments, clients and servers may communicate using any currently known or future developed network protocol, such as the HyperText Transfer Protocol (HTTP), and may be interconnected with any form or medium of digital data communication (such as a communication network). Examples of the communication network include a local area network (LAN), a wide area network (WAN), an inter-network (for example, the Internet), a peer-to-peer network (for example, an ad hoc network), and any network currently known or developed in the future.

The computer-readable medium may be included in the electronic device or may exist alone without being assembled into the electronic device.

The computer-readable medium carries at least one program. When the at least one program is executed by the electronic device, the electronic device is configured to perform the functions below.

A target key video frame is determined.

A target region in the target key video frame is determined.

Target content in the target key video frame is determined based on the target region.

A hot word of a target video to which the target key video frame belongs is determined by processing the target content.

Computer program codes for executing operations in the present disclosure may be written in one or more programming languages or a combination thereof. The preceding programming languages include, but are not limited to, object-oriented programming languages such as Java, Smalltalk, and C++ and may also include conventional procedural programming languages such as C or similar programming languages. Program codes may be executed entirely on a user computer, executed partly on a user computer, executed as a stand-alone software package, executed partly on a user computer and partly on a remote computer, or executed entirely on a remote computer or a server. In the case where the remote computer is involved, the remote computer may be connected to the user computer via any type of network including a local area network (LAN) or a wide area network (WAN) or may be connected to an external computer (for example, via the Internet through an Internet service provider).

The flowcharts and block diagrams in the drawings show the possible architecture, function and operation of the system, method and computer program product according to various embodiments of the present disclosure. In this regard, each block in the flowcharts or block diagrams may represent a module, program segment, or part of codes, where the module, program segment, or part of codes includes at least one executable instruction for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system executing a specified function or operation or may be implemented by a combination of special-purpose hardware and computer instructions.

The units involved in the embodiments of the present disclosure may be implemented by software or hardware. The name of a unit is not intended to limit the unit in a certain circumstance. For example, a target text processing model determination module may also be described as a “model determination module”.

The functions described above herein may be at least partially implemented by at least one hardware logic component. For example, without limitation, example types of hardware logic components that can be used include a field-programmable gate array (FPGA), an application-specific integrated circuit (ASIC), an application-specific standard product (ASSP), a system-on-chip (SoC), a complex programmable logic device (CPLD), and the like.

In the context of the present disclosure, a machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium include an electrical connection based on at least one wire, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof.

According to at least one embodiment of the present disclosure, example one provides a hot word extraction method. The method includes the steps below.

A target key video frame is determined.

A target region in the target key video frame is determined.

Target content in the target key video frame is determined based on the target region.

A hot word of a target video to which the target key video frame belongs is determined by processing the target content.

According to at least one embodiment of the present disclosure, example two provides a hot word extraction method. The method includes the steps below.

Optionally, the step in which the target key video frame is determined includes the steps below.

A current video frame and at least one historical key video frame before the current video frame are acquired.

A similarity value between the current video frame and each historical key video frame among the at least one historical key video frame is determined.

If the similarity value is less than or equal to a preset similarity threshold, the target key video frame is generated based on the current video frame.

According to at least one embodiment of the present disclosure, example three provides a hot word extraction method. The method includes the step below.

Optionally, the target video is generated based on a real-time interactive interface to determine the target key video frame from the target video.

According to at least one embodiment of the present disclosure, example four provides a hot word extraction method. The method includes the step below.

Optionally, in response to detecting a control triggering screen sharing, desktop sharing, or target video playing, a to-be-processed video frame in the target video is collected to determine the target key video frame from the to-be-processed video frame.

According to at least one embodiment of the present disclosure, example five provides a hot word extraction method. The method includes the step below.

Optionally, the step in which the target region in the target key video frame is determined includes the step below.

The target key video frame is input into a pre-trained image feature extraction model, and at least one target region in the target key video frame is determined based on an output result.

According to at least one embodiment of the present disclosure, example six provides a hot word extraction method. The method includes the steps below.

Optionally, the at least one target region includes a target address bar region. The step in which the at least one target region in the target key video frame is determined based on the output result includes the steps below.

The association information of the target key video frame is determined based on the output result.

The target address bar region in the target key video frame is determined based on the association information.

The association information includes the coordinate information of an address bar region in the target key video frame, the foreground confidence information, and the confidence information of an address bar.

According to at least one embodiment of the present disclosure, example seven provides a hot word extraction method. The method includes the step below.

Optionally, the step in which the target content in the target key video frame is determined based on the target region includes the step below.

A target URL address is acquired from the target address bar region to acquire the target content based on the target URL address.

According to at least one embodiment of the present disclosure, example eight provides a hot word extraction method. The method includes the steps below.

Optionally, the at least one target region includes a target text box region. The step in which the at least one target region in the target key video frame is determined based on the output result includes the steps below.

The association information of the target key video frame is determined based on the output result.

The target text box region in the target key video frame is determined based on the association information.

The association information includes the position coordinate information of a text box region in the target key video frame, the foreground confidence information, and the confidence information of the text box region.

According to at least one embodiment of the present disclosure, example nine provides a hot word extraction method. The method includes the steps below.

Optionally, the step in which the at least one target region in the target key video frame is determined includes the steps below.

The target key video frame is processed based on a text line extraction model, and a first feature matrix corresponding to the target key video frame is output. At least one discrete text character region including character content and in the target key video frame is determined based on the first feature matrix. The first feature matrix includes the coordinate information of a discrete text character region and the foreground confidence information.

A least one to-be-determined text line region in the discrete text character region is determined according to preset text character line spacing.

A target text line region in the target key video frame is determined based on the target text box region and the at least one to-be-determined text line region.

According to at least one embodiment of the present disclosure, example ten provides a hot word extraction method. The method includes the step below.

Optionally, the step in which the target text line region in the target key video frame is determined based on the target text box region and the at least one to-be-determined text line region includes the step below.

The target text line region is determined from all of the at least one to-be-determined text line region based on the at least one to-be-determined text line region in the target text box region and an image resolution of a to-be-determined text line region.

According to at least one embodiment of the present disclosure, example eleven provides a hot word extraction method. The method includes the steps below.

Optionally, the text line extraction model is determined. The determination of the text line extraction model includes the steps below.

Training sample data is acquired. The at least one discrete text character region in the video frame, coordinates of a text character region, and confidence of the text character region are pre-marked in the training sample data. The text character region is a discrete region segmented from a continuous text line region.

A to-be-trained text line extraction model is trained based on the training sample data to acquire a training feature matrix corresponding to the training sample data.

Processing is performed based on a loss function, a standard feature matrix in the training sample data, and the training feature matrix; and a model parameter in the to-be-trained text line extraction model is corrected based on a processing result.

A loss function convergence is taken as a training target to acquire the text line extraction model through training.

According to at least one embodiment of the present disclosure, example twelve provides a hot word extraction method. The method includes the step below.

Optionally, the target region includes a target text line region. The step in which the target content in the target key video frame is determined based on the target region includes the step below.

A character in the target text line region is extracted based on image recognition technology and is taken as the target content.

According to at least one embodiment of the present disclosure, example thirteen provides a hot word extraction method. The method includes the steps below.

Optionally, the step in which the hot word of the target video to which the target key video frame belongs is determined by processing the target content includes the steps below.

A preset character in the target content is eliminated to acquire to-be-processed content.

Word segmentation is performed on the to-be-processed content to acquire at least one to-be-processed word, and the hot word of the video to which the target key video frame belongs is acquired based on the at least one to-be-processed word.

According to at least one embodiment of the present disclosure, example fourteen provides a hot word extraction method. The method includes the steps below.

Optionally, the step in which the hot word of the video to which the target key video frame belongs is acquired based on the at least one to-be-processed word includes the steps below.

An average word vector corresponding to all of the at least one to-be-processed word is determined.

For each to-be-processed word, a distance value between each word vector of each to-be-processed word and the average word vector is determined.

It is determined that a to-be-processed word corresponding to a word vector with the smallest distance value from the average word vector serves as a target to-be-processed word, and the hot word of the target key video frame is generated based on the target to-be-processed word.

According to at least one embodiment of the present disclosure, example fifteen provides a hot word extraction method. The method includes the step below.

Optionally, at least one hot word is sent to a hot word cache module so that a corresponding hot word is extracted from the hot word cache module according to speech information in the case where the triggering of a speech-to-text operation is detected.

According to at least one embodiment of the present disclosure, example sixteen provides a hot word extraction apparatus. The apparatus includes a key video frame determination module, a target region determination module, a target content determination module, and a hot word determination module.

The key video frame determination module is configured to determine a target key video frame.

The target region determination module is configured to determine at least one target region in the target key video frame.

The target content determination module is configured to determine target content in the target key video frame based on a target region.

The hot word determination module is configured to determine, by processing the target content, a hot word of a target video to which the target key video frame belongs.

Additionally, although operations are depicted in a particular order, this should not be construed as that these operations are required to be performed in the particular order shown or in a sequential order. In certain circumstances, multitasking and parallel processing may be advantageous. Similarly, although several specific implementation details are included in the preceding discussion, these should not be construed as limiting the scope of the present disclosure. Some features described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or methodological logic acts, it is to be understood that the subject matter defined in the appended claims is not necessarily limited to the particular features or acts described above. Conversely, the particular features and acts described above are merely example forms for implementing the claims.

1. A hot word extraction method, comprising:
determining a target key video frame;
determining a target region in the target key video frame;
determining target content in the target key video frame based on the target region; and
determining, by processing the target content, a hot word of a target video to which the target key video frame belongs.

2. The method according to claim 1, wherein determining the target key video frame comprises:
acquiring a current video frame and at least one historical key video frame before the current video frame;
determining a similarity value between the current video frame and each historical key video frame among the at least one historical key video frame; and
in response to the similarity value being less than or equal to a preset similarity threshold, generating the target key video frame based on the current video frame.

3. The method according to claim 1, further comprising:
generating the target video based on a real-time interactive interface to determine the target key video frame from the target video.

4. The method according to claim 3, further comprising:
in response to detecting a control triggering screen sharing, desktop sharing, or target video playing, collecting a to-be-processed video frame in the target video to determine the target key video frame from the to-be-processed video frame.

5. The method according to claim 1, wherein determining the target region in the target key video frame comprises:
inputting the target key video frame into a pre-trained image feature extraction model, and determining at least one target region in the target key video frame based on an output result.

6. The method according to claim 5, wherein the at least one target region comprises a target address bar region, and determining the at least one target region in the target key video frame based on the output result comprises:
determining association information of the target key video frame based on the output result; and
determining the target address bar region in the target key video frame based on the association information,
wherein the association information comprises coordinate information of an address bar region in the target key video frame, foreground confidence information, and confidence information of an address bar.

7. The method according to claim 6, wherein determining the target content in the target key video frame based on the target region comprises:
acquiring a target uniform resource locator (URL) address from the target address bar region to acquire the target content based on the target URL address.

8. The method according to claim 5, wherein the at least one target region comprises a target text box region, and determining the at least one target region in the target key video frame based on the output result comprises:
determining association information of the target key video frame based on the output result; and
determining the target text box region in the target key video frame based on the association information,
wherein the association information comprises position coordinate information of a text box region in the target key video frame, foreground confidence information and confidence information of the text box region.

9. The method according to claim 8, wherein determining the at least one target region in the target key video frame comprises:
processing the target key video frame based on a text line extraction model, and outputting a first feature matrix corresponding to the target key video frame;
determining, based on the first feature matrix, at least one discrete text character region comprising character content and in the target key video frame, wherein the first feature matrix comprises coordinate information of a discrete text character region of the at least one discrete text character region and foreground confidence information;
determining at least one to-be-determined text line region in the discrete text character region according to preset text character line spacing; and
determining a target text line region in the target key video frame based on the target text box region and the at least one to-be-determined text line region.

10. The method according to claim 9, wherein determining the target text line region in the target key video frame based on the target text box region and the at least one to-be-determined text line region comprises:
determining the target text line region from all of the at least one to-be-determined text line region based on the at least one to-be-determined text line region in the target text box region and an image resolution of a to-be-determined text line region of the at least one to-be-determined text line region.

11. The method according to claim 9, further comprising determining the text line extraction model, wherein
determining the text line extraction model comprises:
acquiring training sample data, wherein the at least one discrete text character region in the video frame, coordinates of a text character region, and confidence of the text character region are pre-marked in the training sample data; and the text character region is a discrete region segmented from a continuous text line region;
training a to-be-trained text line extraction model based on the training sample data to acquire a training feature matrix corresponding to the training sample data;
performing processing based on a loss function, a standard feature matrix in the training sample data, and the training feature matrix, and correcting a model parameter in the to-be-trained text line extraction model based on a processing result; and
taking a loss function convergence as a training target to acquire the text line extraction model through training.

12. The method according to claim 1, wherein the target region comprises a target text line region, and determining the target content in the target key video frame based on the target region comprises:
extracting a character in the target text line region based on an image recognition technology, and taking the text as the target content.

13. The method according to claim 1, wherein determining, by processing the target content, the hot word of the target video to which the target key video frame belongs comprises:
eliminating a preset character in the target content to acquire to-be-processed content; and
performing word segmentation on the to-be-processed content to acquire at least one to-be-processed word, and acquiring, based on the at least one to-be-processed word, the hot word of the video to which the target key video frame belongs.

14. The method according to claim 13, wherein acquiring, based on the at least one to-be-processed word, the hot word of the video to which the target key video frame belongs comprises:
determining an average word vector corresponding to all of the at least one to-be-processed word;
for each to-be-processed word of the at least one to-be-processed word, determining a distance value between each word vector of the each to-be-processed word and the average word vector; and
determining that a to-be-processed word corresponding to a word vector with a smallest distance value from the average word vector serves as a target to-be-processed word, and generating the hot word of the target key video frame based on the target to-be-processed word, wherein the to-be-processed word is among the at least one to-be-processed word.

15. The method according to claim 1, further comprising:
sending at least one hot word to a hot word cache module, wherein a corresponding hot word of the at least one hot word is extracted from the hot word cache module according to speech information in a case where triggering of a speech-to-text operation is detected.

16. (canceled)

17. An electronic device, comprising:
at least one processor; and
a storage apparatus configured to store at least one program,
wherein when executed by the at least one processor, the at least one program causes the at least one processor to perform operations, the operations comprise:
determining a target key video frame;
determining a target region in the target key video frame;
determining target content in the target key video frame based on the target region; and
determining, by processing the target content, a hot word of a target video to which the target key video frame belongs.

18. A non-transitory storage medium comprising computer-executable instructions, wherein when the computer-executable instructions are executed by a computer processor, the following operations are performed:
determining a target key video frame;
determining a target region in the target key video frame;
determining target content in the target key video frame based on the target region; and
determining, by processing the target content, a hot word of a target video to which the target key video frame belongs.

19. The electronic device according to claim 17, wherein determining the target key video frame comprises:
acquiring a current video frame and at least one historical key video frame before the current video frame;
determining a similarity value between the current video frame and each historical key video frame among the at least one historical key video frame; and
in response to the similarity value being less than or equal to a preset similarity threshold, generating the target key video frame based on the current video frame.

20. The electronic device according to claim 17, wherein the operations further comprise:
generating the target video based on a real-time interactive interface to determine the target key video frame from the target video.

21. The electronic device according to claim 20, wherein the operations further comprise:
in response to detecting a control triggering screen sharing, desktop sharing, or target video playing, collecting a to-be-processed video frame in the target video to determine the target key video frame from the to-be-processed video frame.
